(19) United States
(12) Patent Application Publication
(10) Pub. No.: US 2002/0143662 A1
(43) Pub. Date: Oct. 3, 2002

(54) Business management computer program to reduce navigation among screens while preparing a purchase order

(76) Inventors: Jeffrey Scott Clark, Orange, CA (US); John Wendell Grant, Bellflower, CA (US); David Darby Raber, Laguna Beach, CA (US); Robert Clarence Stoldt, Lake Forest, CA (US); Karen Marie Verrengia, Orange, CA (US)

Correspondence Address: Sage Software, Inc., Attn: Leo J. Young, 56 Technology Drive, Irvine, CA, 92618-2301, US

(21) Appl. No.: 09/821,433

(22) Filed: Mar. 29, 2001

(51) Int. Cl. G06F 17/60

(52) U.S. Cl. 705/27

(57) ABSTRACT

A method and apparatus for providing a single screen interactive display to facilitate the purchase of goods and/or services over a global computer network such as the Internet. A single screen interactive program is downloaded form a merchant website to a user computer based on user request. In one embodiment, an apparatus includes a display device including a display, a memory including one or more instructions, and a processor coupled to the memory and display device. The processor, in response to the one or more instructions, provides a catalogue of one or more product categories in a first frame of the display, and provides, in a second frame of the display, a list of one or more products in a product category selected by a user. The list includes an icon next to each product. The processor further provides, in a third frame of the display, a shopping cart list of one or more products added by selection of an icon in the second frame associated with the one or more products.

### BACKGROUND OF THE INVENTION

1. Field of the Invention

The present invention relates generally to business management computer programs, and specifically, to such a computer program for e-commerce that reduces navigation among windows or screens while an operator prepares and edits a purchase order.

2. Background Information

A substantial amount of research and development has been conducted to develop business management computer programs to perform e-commerce functions to aid an operator representing a buyer in preparing and editing a purchase order for electronic transmission to a seller. The Internet is now routinely used for such electronic transmission for the purchase of goods and services online.

Such e-commerce is conducted both on a business-to-business basis (B2B) and on a business-to-consumer (B2C) basis. In any case, a seller either owns or otherwise controls a computer server referred to as a “Web server” that communicates with any of many buyers each of whom has a computer that is sometimes referred to herein as a “client.” The client typically runs a computer program referred to as a “browser” that plays a role in controlling the presentation of “windows” or “screens” to be viewed. Generally, the Web server defines a plurality of Web pages, each of which is associated with a unique address or Uniform Resource Locator (“URL”). The buyer initiates communication by causing the client to transmit, via the Internet, an address containing a URL and a return address identifying the client. Upon initiating a response to the transmitted URL, the Web server transmits control structures and data to cause the client to display a Web page. Typically, these control structures and data are written in HyperText Markup Language (HTML) and include embedded Javascript.

In accordance with prior art e-commerce processes, the Web server is programmed to engage in a sequence of alternating transmissions and receptions whereby a sequence of Web pages are accessed and a corresponding number of windows or screens are displayed at the client. These alternating transmissions and receptions are time consuming and burdensome. From an operator's point of view, the work the operator has to perform to cause the repeated changing from one screen to another is referred to as “navigation.” In preparing a purchase order, the operator navigates from screen-to-screen in a process of viewing offered items, choosing one or more of the items and the quantity of each to be purchased, and verifying that the order as a whole is correct.

Accordingly, there is a need for a user-friendly business management computer program to facilitate e-commerce by reducing the burden of navigation from screen to screen while an operator prepares a purchase order.

### SUMMARY OF THE INVENTION

This invention provides for single-screen shopping. A business management computer program embodies the invention, and a server execute executes it to communicate with a client by transmitting control structures and data to the client to enable the client to control a display. An operator effects single-screen shopping by responding to prompts to prepare and edit a purchase order for at least one item without burdensome navigation among multiple screens, and to transmit the purchase order to the server.

The program comprises means activated in response to receipt of an address from the client to transmit control structures and data for establishing on the display a prompting and reporting screen for effecting single-screen shopping.

The control structures include means for causing the prompting and reporting screen to include a price-list area for showing offered items and a shopping-cart area for showing an extended-price containing list of items copied from the price list.

The program comprises means for providing data defining a set of categories to be shown in the prompting and reporting screen, the set of categories including a plurality of classes for prompting the operator to cause transmission of class-identifying data.

The program comprises means responsive to receipt of the class-identifying data for retrieving and providing data defining the offered items to be shown in the price-list area, for prompting the operator to add items to a purchase order being prepared.

The control structures include means for interactively prompting the operator either to edit the purchase order being prepared or transmit it to the server, the means for interactively prompting including means for providing operator-established data defining the extended-price containing list of items to be shown in the shopping-cart area, the extended-price containing list of items interactively expanding and contracting in terms of number of entries as the operator responds to prompts while effecting single-screen shopping.

A significantly advantageous feature is that the single-screen shopping is facilitated by showing the same item simultaneously in the price-list area and the shopping-cart area. Preferably, each offered item in the price-list area is associated with a displayed control button that the operator can click on to add a unit of the offered item to the shopping cart. Preferably, each item in the extended-price containing list is associated with a displayed control button that the operator can click on to delete a unit of the offered item from the shopping cart.

Other embodiments are described and claimed herein.

### BRIEF DESCRIPTION OF THE DRAWINGS

FIG. 1 is a block diagram of an exemplary set of components used in effecting e-commerce transactions under control of a business management computer program in accordance with this invention.

FIG. 2 is a drawing of a representative single-screen interactive shopping display, according to one embodiment of the present invention.

FIG. 3 is a flow diagram showing the overall flow of actions taken while a server executes a business management computer program to communicate with a client while an operator effects single-screen shopping.

### DETAILED DESCRIPTION

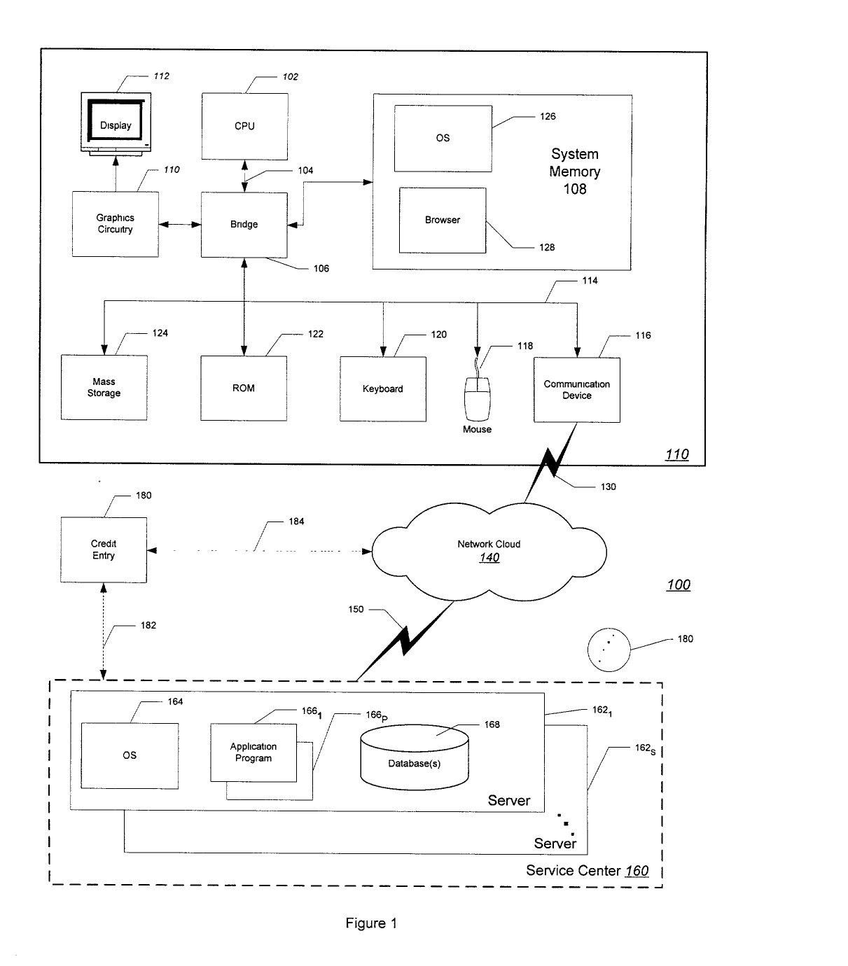

With reference to FIG. 1, a set of components referred to herein as system 100 comprises a client 110 that is a user computer system subject to the control of an operator who represents a buyer. The system 100 includes a communication link 130, a network cloud 140, a communication link 150, and a service center 160. The communication links 130 and 150 couple the client 110 and the service center 160 to the network cloud 140, respectively. In the preferred embodiment, the network cloud includes the Internet, and the system 100 includes many other user computer systems as well as many service centers, designated generally by numeral 170. Alternatively, the network cloud 140 may be a local area network (LAN), wide area network (WAN), Intranet, etc., and combinations thereof.

In the preferred embodiment, service center 160 includes one or more servers 162₁-162_{S} (where “S” is a positive whole number) that are coupled to each other via a LAN or other arrangement. The servers 162₁-162_{S} each include a processor, memory, communication circuitry, and software running thereon. Specifically, server 162₁ includes an operating system 164, one or more application programs 166₁-166_{P} (where “P” is a positive whole number), and one or more databases 168. The databases 168 may include a user database that includes user information (e.g., login ID, name, address, email, authority level, purchase limit, etc.), and a catalogue database that includes one or more catalogues of products and/or services, which may be selected by users. Each catalogue includes associated prices for the products and/or services, and images, text, etc. of the products. The databases 168 may be located on a dedicated server (e.g., 162₂) or on different servers.

One of the application programs is a business management computer program (e.g., 166₁) for a server to execute to communicate with any of many clients such as client 110 by transmitting control structures and data to the client to enable the client to control a display while an operator effects single-screen shopping by responding to prompts to prepare and edit a purchase order for at least one item, and to transmit the purchase order to the server.

The service center 160 may be coupled to one or more verification entities such as entity 180, either directly (dashed line 182) or via the network cloud 140 (dashed line 184), for verification of credit information and for processing credit transactions. It is contemplated for the service center 160 to have other configurations such as, for example, a smaller number of larger computers (i.e. a few mainframe, mini, etc. computers) with a number of internal programs or processes running on the larger computers capable of establishing communication links to the user computer systems.

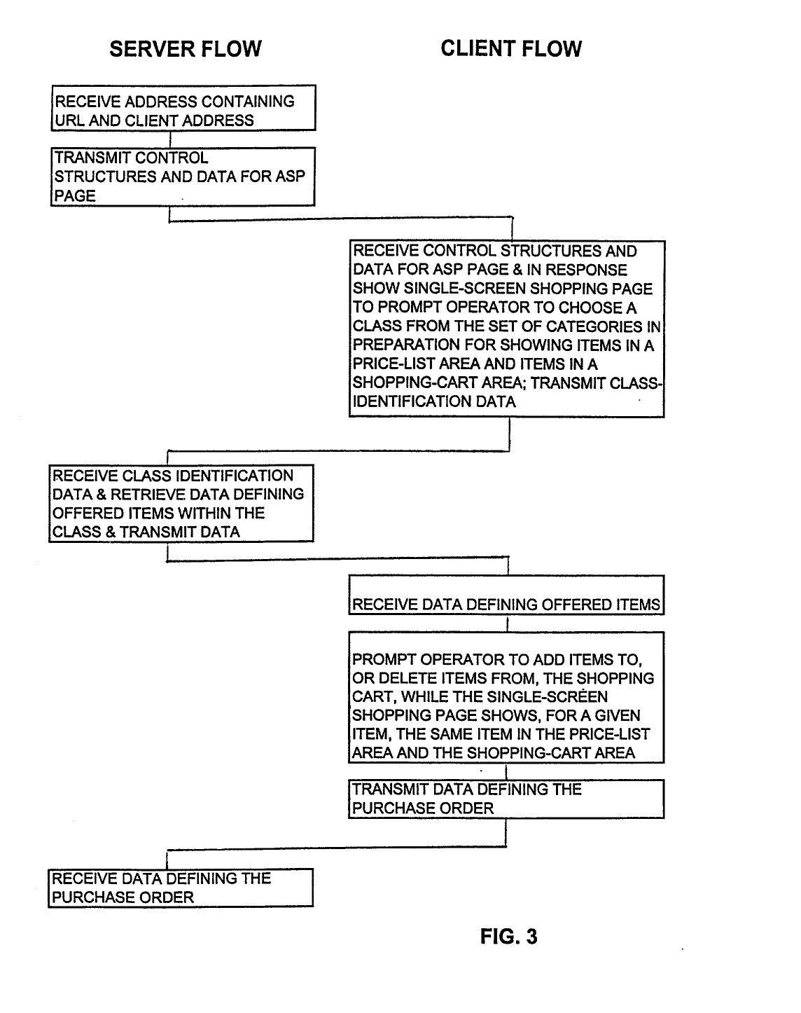

With reference to FIG. 3, there will now be described an overall flow of actions taken while a server executes the business management computer program 166₁ to communicate with a client while an operator effects single-screen shopping.

The relevant flow of actions at the server begins at 301 with the server responding to receipt of an address from the client. The received address includes the URL of a Web page on the server and includes the client address.

In response, the program 166₁ causes the server at 303 to transmit control structures and data to the client to enable the client to control a display for an ASP page.

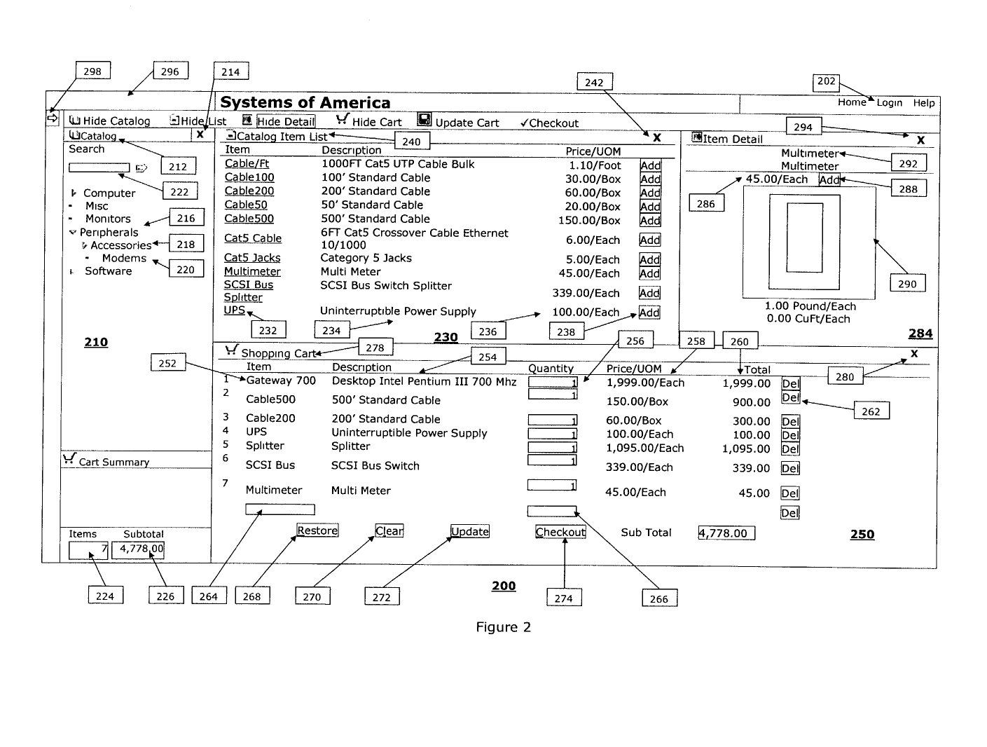

The relevant flow of actions now occurs at the client. At 305, the client receives the transmitted control structures and data. The control structures provide for causing the client to display a prompting and reporting screen 200 (FIG. 2) that includes a price-list area 230 (FIG. 2) for showing offered items and a shopping-cart area 250 (FIG. 2) for showing an extended-price containing list of items copied from the price list.

The data transmitted from the server to the client provides for defining a set of categories to be shown in the prompting and reporting screen, the set of categories including a plurality of classes for prompting the operator to cause transmission of class-identifying data. When the operator chooses one of the set of categories, the client transmits class-identifying data to the server. Following that transmission of class-identifying data, the relevant flow of actions now occurs at the server.

At 307, the program 166₁ causes the server to respond to receipt of the class-identifying data by retrieving and transmitting data defining certain offered items. Following that transmission of offered-item data, the relevant flow of actions now occurs at the client.

At 309, 311, and 313, the client receives data defining the offered items within the chosen class. In response, the client causes the screen 200 (FIG. 2) to show the offered items in the price-list area, for prompting the operator to add items to a purchase order being prepared.

The control structures transmitted from the server to the client include control structures for interactively prompting the operator either to edit the purchase order being prepared or transmit it to the server, as indicted at 315 in FIG. 3. Such interactive prompting leads the operator to provide operator-established data defining the extended-price containing list of items to be shown in the shopping-cart area. The extended-price containing list of items interactively expands and contracts in terms of number of entries as the operator responds to prompts while effecting single-screen shopping. A significant and distinguishing feature is that the single-screen shopping is facilitated by showing the same item simultaneously in the price-list area and the shopping-cart area.

With reference to FIG. 2, the prompting and reporting screen 200 shown therein illustrates a representative example at a representative point of operation. The screen 200 is dynamic, and appears differently at different points of operation, particularly with respect to dynamic content. Although the content is dynamic, preferably a certain consistency of presentation is preferable with respect to the spacial arrangement of areas where the content is displayed.

In the preferred embodiment the spacial arrangement involves the use of frames. A first frame 210 in the screen 200 has a portrait orientation and the content therein includes a catalogue of products listed in a hierarchical manner. The first frame 210 includes a header 212 and an icon 214 for closing the frame 210. The catalogue includes a number of categories 216 such as “Computers,” “Peripherals,” and “Software,” subcategories 218 such as “Misc” and “Accessories,” and products 220 such as “Monitors” and “Modems.” Included in the first frame 210 is a search box 222 for searching for products in the catalogue.

In an alternative approach, the first frame 210 may be replaced by providing a plurality of icons and/or tabs representing categories, subcategories, and/or products/services in a catalogue.

The display 200 includes an area that in the preferred embodiment occupies a second frame that has a landscape orientation and that is referred to herein as the price-list frame 230, and provides for showing offered items. The content shown within the price-list frame 230 includes a list of products and/or services corresponding to the category or type of product 220 selected in the first frame 210. By using a keyboard or mouse, a user may “select” or “click” on a product 220 in the first frame. In response, the client transmits a request to the program 166₂, running on server 162₁, with the latter obtaining the list of products and other information from the catalogue database, and downloads the same to the client. The list of products is then shown in the price-list frame 230. Thus, for example, if “Modems” is selected in the first frame 210, a list of Modems and related products is downloaded and displayed in the price-list frame 230. In the example provided, the list of products 232 include “Cable/FT,” “Cable100,” “Cable200,” “Cable50,” “Cable500,” “Cat5 Cable,” “Cat5 Jacks,” “Multimeter,” “SCSI Bus,” “Splitter,” and “UPS.” Next to each product 232 is a product description field 234 describing the product, a price field 236 providing the price per unit of measure (UOM), and an “Add” icon 238 in the form of a command button for adding a unit of the product to a shopping cart. Inasmuch circumstances can arise in which not all the products can fit in the price-list frame 230, a scroll bar is added so that a user can scroll through the list. The price-list frame 230 also includes a header 240 and an icon 242 for closing the second frame 230.

In another embodiment, the entire catalogue including the list of products, descriptions, and pricing may be downloaded with the single screen interactive shopping program so that requests to the service center 160 are not needed and the potential for network congestion is avoided. However, this may need to be balanced against the downloading time of the single screen interactive shopping application given the size of the catalogue.

The display 200 includes a shopping-cart area that in the preferred embodiment occupies a third frame that has a landscape orientation and that is referred to herein as the shopping cart frame 250, and provides for showing an extended-price containing list of items copied from the price list. The shopping cart frame 250 includes a listing of each product 252 added to the shopping cart frame. In the exemplary display 200 seven products are added to the shopping cart frame including “Gateway700,” “Cable500,” “Cable200,” “UPS,” “Splitter,” “SCSI Bus,” and “Multimeter.” Next to each item added to the shopping cart frame 250 is a product description field 254 describing the product added, a quantity box 256 specifying the quantity of a product added, a price field 258 which specifies the price of the product per UOM, a total field 260 specifying the total price for the specific product, and a delete icon 262 which allows the user to delete the product from the shopping cart frame 250. The shopping cart frame 250 also includes a box 264 to allow the user to add a product to the shopping cart frame 250 manually by entering the product number or description, and a quantity box 266 for specifying the quantity of the product.

In the shopping cart frame 250, a subtotal box 276 provides for displaying the subtotal for all products added to the shopping cart frame. The bottom portion of the first frame 210 may optionally include an items box 224 specifying the number of items in the shopping cart frame 250, and a subtotal box 226.

One way to increase the quantity of a specific product is for the user to select the Add icon 238 next to the product in the second frame 230. Another way to increase the quantity, or to decrease the quantity, is for the user to “click” in the quantity box 256 corresponding to the desired product, change the number using a keyboard, and then press the <enter> key. The total field 260 corresponding to that product will automatically be updated. If the Del icon 262 is selected, the product is removed from the shopping cart frame.

The shopping cart frame 250 additionally includes a “Restore” icon 268, “Clear” icon 270, “Update” icon 272, and “Checkout” icon 274. The “Clear” icon 270 clears all items added to the shopping cart frame 250. The “Update” icon 272 stores (or posts) a user's current setting including the products/items added to the shopping cart frame 250, to a database (e.g., database 168, FIG. 1) on the seller's website, under the user's login ID. Thus, a user may add and delete products to the shopping cart frame 250 immediately and locally without sending a request back to the server 162₁. The user can then save the current settings by selecting the “Update” icon 272 and posting the setting to the server. The setting can be retrieved from the database at any time by selecting the “Restore” icon 268. This is typically done after the user logins in by selecting the login icon 202 and entering in a login ID. The “Checkout” icon 274 allows the user to purchase the items added to the shopping cart frame 250. The shopping cart frame 250 includes a header 278 and an icon 280 for “hiding” or closing the shopping cart frame 250.

The display 200 may optionally include a fourth frame 284 occupying a portion of the display 200, and which includes a picture 290 and/or narrative of a product selected. That is, the user may view a picture and/or obtain a longer narrative of the product by selecting a product item 232 in the second frame 230 or by selecting a product item 252 in the shopping cart frame 250. The fourth frame 284 includes a price field 286 showing the price of the product, and an Add icon 288 to allow the user to add the product to the shopping cart frame 250. Also included in the fourth frame 284 is a product name field 292 which includes the product name, and an icon 294 for closing the fourth frame 284.

The display 200 may further include an optional header frame 296 which may include the name of the entity selling the products, an optional header frame 298 which includes four icons for “hiding” the four respective frames, an update cart icon, and a checkout icon. Other icons may be included in the header frame 298.

With reference again to FIG. 1, the client 110 comprises a processor or a central processing unit (CPU) 102 that includes an Arithmetic Logic Unit (ALU) for performing computations, a collection of registers for temporary storage of data and instructions, and a control unit for controlling operation for the system 100.

The CPU 102 is coupled to a bus bridge 106 by way of a CPU bus 104. The bus bridge 106 includes a memory controller integrated therein (not shown), though the memory controller may be external to the bus bridge 106. The memory controller provides an interface for access by the CPU 102 or other devices to system memory 108. In one embodiment, the system memory 108 includes synchronous dynamic random access memory (SDRAM). System memory 108 may optionally include any additional or alternative high speed memory device or memory circuitry. The bus bridge 106 is coupled to graphics circuitry 110 for controlling a display device 112. The graphics circuitry 110 includes a video controller, video memory for storing display data to be displayed on the display device 112, and video BIOS that includes code and video services for controlling the video controller, as is well known in the art (not shown). In another embodiment, the graphics circuitry 110 is coupled to the CPU 102 through an Advanced Graphics Port (AGP) bus.

The display device 112 includes a display screen that may be a CRT monitor, a television which is connected to a set top box, a laptop display, or the like. Navigation through the graphical user interface may be provided through the use of control buttons on a remote control unit, or by other means known in the art.

The bus bridge 106 is also coupled to a system bus 114 that may be a peripheral component interconnect (PCI) bus, Industry Standard Architecture (ISA) bus, etc., and combinations thereof. Coupled to the system bus 114 are a communication device 116, mouse 118, keyboard 120, non-volatile memory 122, and mass storage 124. One or more other input/output (I/O) devices (now shown) may also be coupled to the system bus 114.

The mass storage device 124 may be any of numerous types of such devices including a hard disk, floppy disk, CD-ROM, DVD-ROM, tape, high density floppy, high capacity removable media, low capacity removable media, solid state memory device, etc., and combinations thereof. The non-volatile memory 122 may be a read-only memory (ROM), Flash memory, etc., and includes system BIOS for controlling, among other things, hardware devices in the computer system 110. The communication device 116 includes a network card, a modem interface, etc. for accessing the network cloud 140 via communications link 130.

As is familiar to those skilled in the art, the client 110 further includes an operating system 126, which is loaded into system memory 108 from mass storage device 124 and launched after power on self test. The operating system 126 is a set of one or more programs which control the computer system's operation and the allocation of resources, and may include any type of operating system including, but not limited or restricted to, DOS, Windows™ (e.g., Windows 95™, Windows 98™, Windows NT™), Unix, Linux, OS/2, OS/9, Xenix, etc. Also loaded into memory 108 of the computer system 110, when launched by a user, is a browser program 128 for accessing websites such as websites on the service center 160 and viewing the single-screen interactive display of the present invention. The browser program 128 may include the Microsoft Internet Explorer™, Netscape Navigator™, or other suitable program for displaying the single-screen interactive display of the present invention.

The present invention thus provides a method and apparatus for a single screen interactive display that allows a consumer to search for products in a catalogue, view products available in the catalogue including product descriptions, price, and optionally an image of the product, while at the same time viewing a detail itemized list of a shopping cart. This allows consumers to perform searches for products, view product details, add products to a shopping cart, and view the shopping cart details, without the need to go back and forth to different web pages. Consequently, the shopping experience of a consumer over a global computer network is facilitated and enhanced.

Copyright Notice and Authorization

The following Appendix is subject to copyright protection.

(C) Sage Software, Inc. 2000. All rights reserved.

The copyright owner, Sage Software, Inc., has no objection to the facsimile reproduction by any one of the patent disclosure, as it appears in the Patent and Trademark Office patent files or records of any country, but otherwise reserves all rights whatsoever.

Appendix A contains a listing of portions of the control structures and data transmitted from the server to a client in accordance with a representative example of operation of a preferred embodiment. One portion, headed “Catalog List Frame,” concerns control structures and data for frame 230. A portion headed “Category Frame” concerns control structures and data for frame 210. A portion headed “Shopping Cart Frame” concerns control structures and data for frame 250. A portion headed “Order Entry” concerns software for overall management control of the display of the frames.

[image]

[image]

[image]

[image]

[image]

[image]

[image]

[image]

[image]

[image]

[image]

[image]

[image]

[image]

[image]

[image]

[image]

[image]

[image]

[image]

We claim:

1. A business management computer program for a server to execute to communicate with a client by transmitting control structures and data to the client to enable the client to control a display while an operator effects single-screen shopping by responding to prompts to prepare and edit a purchase order for at least one item without burdensome navigation among multiple screens, and to transmit the purchase order to the server, the program comprising:
means activated in response to receipt of an address from the client to transmit control structures and data for establishing on the display a prompting and reporting screen for effecting single-screen shopping;
the control structures including means for causing the prompting and reporting screen to include a price-list area for showing offered items and a shopping-cart area for showing an extended-price containing list of items copied from the price list;
means for providing data defining a set of categories to be shown in the prompting and reporting screen, the set of categories including a plurality of classes for prompting the operator to cause transmission of class-identifying data;
means responsive to receipt of the class-identifying data for retrieving and providing data defining the offered items to be shown in the price-list area, for prompting the operator to add items to a purchase order being prepared;
the control structures including means for interactively prompting the operator either to edit the purchase order being prepared or transmit it to the server, the means for interactively prompting including means for providing operator-established data defining the extended-price containing list of items to be shown in the shopping-cart area, the extended-price containing list of items interactively expanding and contracting in terms of number of entries as the operator responds to prompts while effecting single-screen shopping that is facilitated by showing the same item simultaneously in the price-list area and the shopping-cart area.

2. An apparatus for providing a single screen interactive display, comprising:
a display device for displaying a prompting and reporting screen;
a memory including a plurality of instructions;
a processor coupled to the memory and display device, the processor, in response to the instructions, causing the display device to display within the prompting and reporting screen:
a catalogue of one or more product categories;
an offered-items list of one or more products in a product category selected by a user, the offered-items list including an icon next to each product; and
a shopping cart list of one or more products added by selection of an icon in the offered-items list,
the prompting and reporting screen showing the same item simultaneously in the price-list area and the shopping-cart area.

3. The apparatus of claim 2 wherein the processor causes the the prompting and reporting screen to provide, in a designated area, an image of a selected product.

4. The apparatus of claim 2 wherein the offered-items list includes a price and a description associated with each product.

5. The apparatus of claim 2 wherein said shopping cart list includes one or more of a description, price, quantity, and total price associated with each product.

6. The apparatus of claim 2, and further including a subtotal field that specifies the total price of the one or more products in the shopping cart list.

7. The apparatus of claim 2, and further including an update icon to cause the processor to transmit a current state including values in the shopping cart list to a server over a network.

8. The apparatus of claim 7, and further including a restore icon to cause the processor to retrieve the current state from the servers.

9. A computer program product, comprising:
a computer usable medium having computer program code embodied therein to display a catalogue of one or more product categories in a first portion of a display screen;
computer readable program code to display, in a second portion of the display screen, a list of one or more products in a product category selected by a user, said list including an icon next to each product; and
computer readable program code to display, in a third portion of the display screen a shopping cart list of one or more products added by selection of an icon in the second portion of the display screen associated with the one or more products, the third portion having a landscape orientation, and the shopping cart list and the list of products in operation showing the same item simultaneously.

10. The computer program product of claim 9 further comprising:
computer readable program code to display, in a fourth portion of the display screen, an image of a selected product.

11. The computer program product of claim 9 further comprising computer readable program code to display, in the second portion of the display screen, a price and a description associated with each product.

12. The computer program product of claim 9 further comprising computer readable program code to display, in the third portion of the display screen, one or more of a description, price, quantity, and total price associated with each product.

13. The computer program product of claim 9 further comprising computer readable program code to display, in the third portion of the display screen, a subtotal field that specifies the total price of the one or more products in the shopping cart list.

14. The computer program product of claim 9 further comprising computer readable program code to display, in the third portion of the display screen, an update icon to cause the processor to transmit a current state including values in the shopping cart list to a server over a network.

15. The computer program product of claim 9 further comprising computer readable program code to display, in the third portion of the display screen, a restore icon to cause the processor to retrieve the current state from the servers.
